(19) United States
(12) Patent Application Publication
(10) Pub. No.: US 2010/0233514 A1
(43) Pub. Date: Sep. 16, 2010

(54) RESIN STAMPER FOR PATTERN TRANSFER AND MAGNETIC RECORDING MEDIUM MANUFACTURING METHOD USING THE SAME

(75) Inventors: Kazuyo Umezawa, Yokohama-shi (JP); Seiji Morita, Yokohama-shi (JP); Shinobu Sugimura, Yokohama-shi (JP); Masatoshi Sakurai, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/723,380

(22) Filed: Mar. 12, 2010

(30) Foreign Application Priority Data
Mar. 13, 2009 (JP) 2009-060932

(51) Int. Cl. G11B 5/00; B05C 1/00; C23F 1/00

(52) U.S. Cl. 428/826; 118/200; 216/22

(57) ABSTRACT

According to one embodiment, pattern transfer is performed using a combination of an ultraviolet-curable resin having a surface tension of 31 to 39 mN/m and a stamper having a critical surface tension of 31 mN/m or less.

### CROSS-REFERENCE TO RELATED APPLICATIONS

This application is based upon and claims the benefit of priority from Japanese Patent Application No. 2009-060932, filed Mar. 13, 2009, the entire contents of which are incorporated herein by reference.

### BACKGROUND

1. Field

One embodiment of the present invention relates to a method of manufacturing a magnetic recording medium having discrete tracks on the surface of a magnetic recording layer and, more particularly, to a resin stamper to be used when transferring a discrete track shape.

2. Description of the Related Art

Recently, the nano-imprinting techniques are attracting attention in various fields in order to further increase the density and accuracy.

For example, applications to semiconductors, optical elements, magnetic recording media, and the like are being examined.

As a magnetic recording medium, a discrete track medium is attracting attention. In this discrete track medium, magnetic interference between adjacent recording tracks is reduced by separating the adjacent tracks by grooves or guard bands made of a nonmagnetic material, in order to further increase the density.

When manufacturing this discrete track medium, discrete track patterns of a magnetic layer can be formed by applying the nano-imprinting technique by using a stamper. When magnetic layer patterns corresponding to servo area signals are formed together with recording track patterns by imprinting, it is possible to obviate the servo track writing step required in the manufacture of the conventional magnetic recording media. This leads to a cost reduction.

As the process of forming discrete track patterns as described above, a process of transferring resist patterns from an Ni stamper by, e.g., high-pressure imprinting or thermal imprinting has been used. Unfortunately, this process is unsuitable for mass-production because the life of the Ni stamper is short. Also, when the data density is increased to make tracks finer, resist patterns cannot be well transferred.

From the foregoing, the use of optical nano-imprinting is attracting attention as another nano-imprinting technique.

To transfer patterns onto a resist on a discrete track medium by using optical nano-imprinting, a resin stamper is first duplicated from an Ni stamper (mother stamper) by injection molding, and bonded in a vacuum to an uncured ultraviolet-curable resin layer to be used as a resist. This method is found to be able to reduce the cost and suitable for micropatterning.

The characteristics required of the ultraviolet-curable resin to be transferred onto the above-mentioned discrete track medium are the property of coating onto the medium, the viscosity, the curing property, the property of separation from the resin stamper, the resistance against etching for processing transferred patterns, and the cure shrinkage. The thickness of the ultraviolet-curable resin must be sufficient for imprinting with respect to the height of the three-dimensional structure of transfer patterns. For later processing steps, however, the amount of residue of the ultraviolet-curable resin after imprinting is preferably small. Therefore, the coating film thickness of the ultraviolet-curable resin layer is desirably 60 nm or less.

An example of the ultraviolet-curable resin for radical polymerization is an ultraviolet-curable resin obtained by mixing an initiator, an oligomer having a vinyl (acryloyl) group, and a monomer. However, when an oligomer is mixed in an ultraviolet-curable resin, the viscosity increases, and this makes it difficult to decrease the coating film thickness to 60 nm or less.

Also, as disclosed in Jpn. Pat. Appln. KOKAI Publication No. 2008-19292, an example of the ultraviolet-curable resin for nano-imprinting is an ultraviolet-curable resin to which a surfactant is added to improve the coating property and the property of separation. If the surfactant is used too much, however, curing inhibition readily occurs, the curing time tends to prolong, or the magnetic recording medium often deteriorates.

In addition, since the coating film thickness must be very small, i.e., 60 nm or less, film thickness control is difficult to perform unless the viscosity of the ultraviolet-curable resin is 15 cP or less.

If a monofunctional monomer alone is cured, the curing property of the film degrades. On the other hand, if the functional order is increased, the film cures, but the cure shrinkage readily increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A, 1B, 1C, and 1D are views showing a pattern transfer method to be used in the present invention;

FIG. 2 is a view showing a magnetic recording/reproduction apparatus for performing recording and reproduction on a magnetic recording medium; and

FIGS. 3A, 3B, 3C, 3D, 3E, 3F, 3G, 3H, 3I, 3J, and 3K are views showing an example of a discrete magnetic recording medium manufacturing method.

### DETAILED DESCRIPTION

Various embodiments according to the invention will be described hereinafter with reference to the accompanying drawings. In general, according to one embodiment of the invention, a pattern transfer stamper is provided and is used in combination with ultraviolet-curable resin having a surface tension of 31 to 39 mN/m, and characterized by having three-dimensional patterns to be transferred via a coating layer of the ultraviolet-curable resin having the above-mentioned surface tension in order to form track patterns on the surface of a recording layer of a recording medium, and having a critical surface tension of 31 mN/m or less.

The three-dimensional patterns can have a main region corresponding to a data area including a data recording portion and address portion of a recording medium, and a dummy region other than the main region.

The critical surface tension of the stamper as a solid can be measured by the Zisman method. The critical surface tension can be measured by using a mirror-surface portion having no three-dimensional structure, of the three-dimensional pattern formation surface of the resin stamper. The measurement apparatus used is prop Master 500 image processing type solid-liquid interface analyzing system manufactured Kyowa Interface Science. Four wetting tension test mixture reagents 31, 34, 37, and 40 available from Wako Pure Chemical were used as test solutions, and a contact angle θ with each reagent was measured. Extrapolation was performed based on the relationship between the surface tension of the reagent and cos θ of the contact angle. A surface tension when cos θ=1 can be regarded as the critical surface tension.

On the other hand, the surface tension of the ultraviolet-curable resin as a liquid can be measured with Automatic Surface Tensiometer CBVP-Z manufactured by Kyowa Interface Science by using, e.g., the plate method (Wilhelmy method).

Also, a magnetic recording medium manufacturing method uses a combination of a pattern formation stamper having a critical surface tension of 31 mN/m or less, and an ultraviolet-curable resin having a surface tension of 31 to 39 mN/m. The method includes bonding, in a vacuum, the surface of a magnetic recording layer of a magnetic recording medium and the three-dimensional pattern surface of a stamper having a critical surface tension of 31 mN/m or less with a coating layer of an uncured ultraviolet-curable resin having a surface tension of 31 to 39 mN/m being interposed between them,

curing the coating layer of the uncured ultraviolet-curable resin by ultraviolet irradiation,

separating the resin stamper to form, on one surface of the magnetic recording medium, a cured ultraviolet-curable resin layer onto which three-dimensional patterns are transferred, and

performing dry etching by using the cured ultraviolet-curable resin layer as a mask, thereby forming the three-dimensional patterns on the surface of the magnetic recording layer.

The present invention uses the combination of the ultraviolet-curable resin having a surface tension of 31 to 39 mN/m and the stamper having a critical surface tension of 31 mN/m or less. This improves the property of separation between the stamper and the cured ultraviolet resin layer after vacuum bonding and ultraviolet curing in the manufacture of a discrete magnetic recording medium. This makes accurate pattern transfer feasible.

Also, if the critical surface tension of the stamper is higher than 31 mN/m, the residue of the ultraviolet-curable resin readily forms upon separation after vacuum bonding.

The surface tension of the ultraviolet-curable resin can further be 31 to 36 mN/m.

Likewise, the critical surface tension of the stamper can further be 26 to 31 mN/m. If the critical surface tension is less than 26, it is often difficult to transfer fine patterns from an Ni stamper.

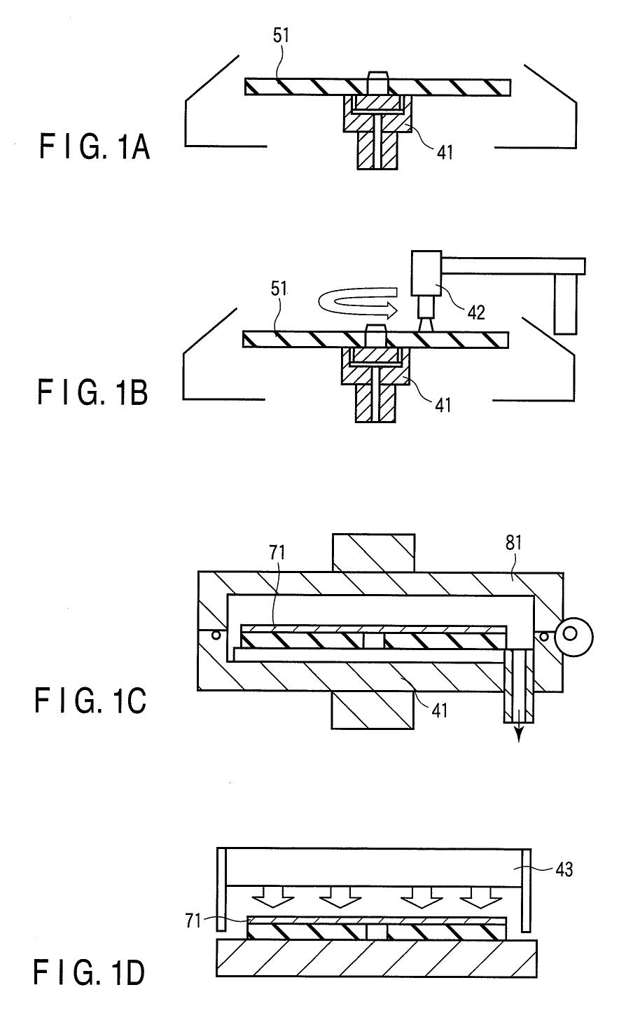

An outline of a pattern transfer method to be used in the present invention will be explained below with reference to FIGS. 1A to 1D.

FIGS. 1A to 1D illustrate the transfer of patterns onto one surface of a medium substrate. As shown in FIG. 1A, a medium substrate 51 is set on a spinner 41. As shown in FIG. 1B, while the medium substrate 51 is spun together with the spinner 41, an ultraviolet-curable resin (2P resin) is dropped from a dispenser 42 and spin-coated. As shown in FIG. 1C, in a vacuum chamber 81, one surface of the magnetic recording medium 51 and a pattern surface of a transparent stamper 71 are bonded in a vacuum with a 2P resin layer (not shown) being interposed between them. As shown in FIG. 1D, the 2P resin layer is cured by emitting UV radiation from a UV light source 43 through the transparent stamper 71 at atmospheric pressure. After the step shown in FIG. 1D, the transparent stamper 71 is separated.

Examples of a magnetic disk substrate usable in the present invention are a glass substrate, an Al-based alloy substrate, a ceramic substrate, a carbon substrate, an Si single-crystal substrate having an oxidized surface, and a substrate obtained by forming an NiP layer on the surface of any of these substrates. As the glass substrate, amorphous glass or crystallized glass can be used. Examples of the amorphous glass are soda lime glass and alumino-silicate glass. An example of the crystallized glass is lithium-based crystallized glass. As the ceramic substrate, it is possible to use a sintered product mainly containing aluminum oxide, aluminum nitride, or silicon nitride, or a material formed by fiber-reinforcing the sintered product. Plating or sputtering is used to form the NiP layer on the substrate surface.

When manufacturing a perpendicular magnetic recording medium, a so-called perpendicular double-layered medium can be formed by forming a perpendicular magnetic recording layer on a soft magnetic underlayer (SUL) on a substrate. The soft magnetic underlayer of the perpendicular double-layered medium passes a recording magnetic field from a recording magnetic pole, and returns the recording magnetic field to a return yoke placed near the recording magnetic pole. That is, the soft magnetic underlayer performs a part of the function of a recording head; the soft magnetic underlayer applies a steep perpendicular magnetic field to the recording layer, thereby increasing the recording efficiency.

An example of the soft magnetic underlayer usable in the present invention is a high-k material containing at least one of Fe, Ni, and Co. Examples of the material are FeCo-based alloys such as FeCo and FeCoV, FeNi-based alloys such as FeNi, FeNiMo, FeNiCr, and FeNiSi, FeAl-based and FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN.

As the soft magnetic underlayer, it is also possible to use a material having a microcrystal structure such as FeAlO, FeMgO, FeTaN, or FeZrN containing 60 atomic % or more of Fe, or a material having a granular structure in which fine crystal grains are dispersed in a matrix.

As another material of the soft magnetic underlayer, it is possible to use a Co alloy containing Co and at least one of Zr, Hf, Nb, Ta, Ti, and Y. The content of Co can be 80 atomic % or more. An amorphous layer is readily formed when a film of the Co alloy is formed by sputtering. The amorphous soft magnetic material has none of magnetocrystalline anisotropy, a crystal defect, and a grain boundary, and hence has superb soft magnetism. It is also possible to reduce the noise of the medium by using the amorphous soft magnetic material. Favorable examples of the amorphous soft magnetic material are CoZr-based, CoZrNb-based, and CoZrTa-based alloys.

Another underlayer may also be formed below the soft magnetic underlayer in order to improve the crystallinity of the soft magnetic underlayer or improve the adhesion to the substrate. As the underlayer material, it is possible to use Ti, Ta, W, Cr, Pt, an alloy containing any of these materials, or an oxide or nitride of any of these materials.

An interlayer made of a nonmagnetic material can be formed between the soft magnetic underlayer and perpendicular magnetic recording layer. The interlayer interrupts the exchange coupling interaction between the soft magnetic underlayer and recording layer, and controls the crystallinity of the recording layer. As the interlayer material, it is possible to use Ru, Pt, Pd, W, Ti, Ta, Cr, Si, an alloy containing any of these materials, or an oxide or nitride of any of these materials.

To prevent spike noise, it is possible to divide the soft magnetic underlayer into a plurality of layers, and antiferromagnetically couple these layers with 0.5- to 1.5-nm-thick Ru films being sandwiched between them. Also, the soft magnetic layer can be coupled by exchange coupling with a hard magnetic film having in-plane anisotropy such as CoCrPt, SmCo, or FePt, or a pinning layer made of an antiferromagnetic material such as IrMn or PtMn. To control the exchange coupling force, a magnetic layer such as a Co layer or a nonmagnetic layer such as a Pt layer can be stacked above and below the Ru layer.

As the perpendicular magnetic recording layer usable in the present invention, it is possible to use a material mainly containing Co, containing at least Pt, containing Cr as needed, and further containing an oxide (e.g., silicon oxide or titanium oxide). In this perpendicular magnetic recording layer, the magnetic crystal grains can form a pillar structure. In the perpendicular magnetic recording layer having this structure, the orientation and crystallinity of the magnetic crystal grains are favorable. As a consequence, a signal-to-noise ratio suitable for high-density recording can be obtained. The amount of oxide is important to obtain the above structure. The content of the oxide can be 3 to 12 mol %, and can also be 5 to 10 mol %, with respect to the total amount of Co, Pt, and Cr. When the content of the oxide in the perpendicular magnetic recording layer falls within the above range, the oxide deposits around the magnetic grains, so the magnetic grains can be isolated and downsized. If the content of the oxide exceeds the above range, the oxide remains in the magnetic grains and deteriorates the orientation and crystallinity of the magnetic grains. Furthermore, the oxide deposits above and below the magnetic grains. Consequently, the pillar structure in which the magnetic grains vertically extend through the perpendicular magnetic recording layer is often not formed. On the other hand, if the content of the oxide is less than the above range, the magnetic grains are insufficiently isolated and downsized. As a result, noise increases during recording and reproduction, and this often makes it impossible to obtain a signal-to-noise ratio suited to high-density recording.

The content of Pt in the perpendicular magnetic recording layer can be 10 to 25 atomic %. When the Pt content falls within the above range, a uniaxial magnetic anisotropy constant Ku necessary for the perpendicular magnetic recording layer is obtained. In addition, the crystallinity and orientation of the magnetic grains improve. Consequently, a thermal decay characteristic and recording/reproduction characteristic suited to high-density recording are obtained. If the Pt content exceeds the above range, a layer having the fcc structure is formed in the magnetic grains, and the crystallinity and orientation may deteriorate. On the other hand, if the Pt content is less than the above range, it is often impossible to obtain Ku, i.e., a thermal decay characteristic suitable for high-density recording.

The content of Cr in the perpendicular magnetic recording layer can be 0 to 16 atomic %, and can also be 10 to 14 atomic %. When the Cr content falls within the above range, it is possible to maintain high magnetization without decreasing the uniaxial magnetic anisotropy constant Ku of the magnetic grains. Consequently, a recording/reproduction characteristic suited to high-density recording and a sufficient thermal decay characteristic are obtained. If the Cr content exceeds the above range, the thermal decay characteristic worsens because Ku of the magnetic grains decreases. In addition, the crystallinity and orientation of the magnetic grains worsen. As a consequence, the recording/reproduction characteristic tends to worsen.

The perpendicular magnetic recording layer can contain one or more additive elements selected from B, Ta, Mo, Cu, Nd, W, Nb, Sm, Tb, Ru, and Re, in addition to Co, Pt, Cr, and the oxide. These additive elements can promote the downsizing of the magnetic grains, or improve the crystallinity and orientation of the magnetic grains. This makes it possible to obtain a recording/reproduction characteristic and thermal decay characteristic more suitable for high-density recording. The total content of these additive elements can be 8 atomic % or less. If the total content exceeds 8 atomic %, a phase other than the hcp phase is formed in the magnetic grains, and this disturbs the crystallinity and orientation of the magnetic grains. As a result, it is often impossible to obtain a recording/reproduction characteristic and thermal decay characteristic suited to high-density recording.

Other examples of the material of the perpendicular magnetic recording layer are a CoPt-based alloy, a CoCr-based alloy, a CoPtCr-based alloy, CoPtO, CoPtCrO, CoPtSi, and CoPtCrSi. As the perpendicular magnetic recording layer, it is also possible to use a multilayered film containing Co and an alloy mainly containing at least one element selected from the group consisting of Pt, Pd, Rh, and Ru. It is further possible to use a multilayered film such as CoCr/PtCr, CoB/PdB, or CoO/RhO obtained by adding Cr, B, or O to each layer of the former multilayered film.

The thickness of the perpendicular magnetic recording layer can be 5 to 60 nm, and can also be 10 to 40 nm. A perpendicular magnetic recording layer having a thickness falling within this range is suited to a high recording density. If the thickness of the perpendicular magnetic recording layer is less than 5 nm, the reproduction output becomes too low, so the noise component often becomes higher than the reproduction output. On the other hand, if the thickness of the perpendicular magnetic recording layer exceeds 40 nm, the reproduction output becomes too high and tends to distort the waveform. The coercive force of the perpendicular magnetic recording layer can be 237,000 A/m (3,0000e) or more. If the coercive force is less than 237,000 A/m (3,0000e), the thermal decay resistance tends to decrease. The perpendicular squareness ratio of the perpendicular magnetic recording layer can be 0.8 or more. If the perpendicular squareness ratio is less than 0.8, the thermal decay resistance often decreases.

A protective layer can be formed on the perpendicular magnetic recording layer.

The protective layer prevents the corrosion of the perpendicular magnetic recording layer, and also prevents damages to the medium surface when a magnetic head comes in contact with the medium. Examples of the material of the protective layer are materials containing C, SiO₂, and ZrO₂. The thickness of the protective layer can be 1 to 10 nm. When the thickness of the protective layer falls within the above range, the distance between the head and medium can be decreased. This is suitable for high-density recording.

The surface of the perpendicular magnetic recording medium can be coated with a lubricant, e.g., perfluoropolyether, fluorinated alcohol, or fluorinated carboxylic acid.

As the ultraviolet-curable resin material to be used in the present invention, it is possible to use a composition containing at least isobornyl acrylate as a monomer, trifunctional acrylate or urethane acrylate, and a polymerization initiator. In addition, 1 wt % or less of an addition such as an adhesive or release agent can also be mixed.

The content of isobornyl acrylate is 40 to 95 wt %, that of the trifunctional acrylate is 1 to 30 wt %, and that of the polymerization initiator is 0.5 to 6 wt %.

As the trifunctional acrylate, it is possible to use, e.g., trimethylolpropane triacrylate,

trimethylolpropane PO-modified triacrylate

(number of propoxy groups [POs]: 2, 3, 4, 6),

trimethylolpropane EO-modified triacrylate

(number of ethoxy groups [EOs]: 3, 6, 9, 15, 20),

tris(2-hydroxyethyl)isocyanurate triacrylate,

pentaerythritol triacrylate,

pentaerythritol EO-modified triacrylate,

EO-modified glycerin triacrylate,

propoxylated (3) glyceryl triacrylate,

highly propoxylated (5.5) glyceryl triacrylate,

trisacryloyloxyethyl phosphate, and

ε-caprolactone-modified

tris(acryloxyethyl)isocyanurate.

As the polymerization initiator, it is possible to use, e.g., an alkylphenone-based photopolymerization initiator, acylphosphine oxide-based polymerization initiator, titanocene-based polymerization initiator, oxime ester-based photopolymerization initiator, and oxime ester acetate-based photopolymerization initiator.

Practical examples of the above-mentioned polymerization initiators are
2,2-dimethoxy-1,2-diphenylethane-1-on (Irgacure 651 manufactured by Ciba Specialty Chemicals),
1-hydroxy-cyclohexyl-phenyl-ketone (Irgacure 184 manufactured by Ciba Specialty Chemicals), and
2-hydroxy-2-methyl-1-phenyl-propane-1-on (Darocur 1173 manufactured by Ciba Specialty Chemicals).

Other examples are Irgacure 2959, Irgacure 127, Irgacure 907, Irgacure 369, Irgacure 379, Darocur TPO, Irgacure 819, Irgacure 784, Irgacure OXE 01, Irgacure OXE 02, and Irgacure 754 (all manufactured by Ciba Specialty Chemicals).

Isobornyl acrylate has a relatively low viscosity of 9 CP and a high Tg. Also, isobornyl acrylate tends to have a high etching resistance because it has an alicyclic structure.

The etching resistance tends to further increase when acrylate having an adamantane ring structure or aromatic ring structure is added to this ultraviolet-curable resin.

When the ultraviolet-curable resin contained only isobornyl acrylate and the polymerization initiator, the hardness of the cured film was insufficient. The hardness of the cured film was insufficient even when a monofunctional monomer, a bifunctional monomer, and isobornyl acrylate were combined. When a trifunctional monomer was combined, the hardness of the cured film was sufficient while the etching resistance remained high. A polyfunctional monomer having an order higher than that of a trifunctional monomer is not readily usable in the low-viscosity, ultraviolet-curable resin for this purpose because the viscosity increases.

It is necessary to select an optimum polymerization initiator in accordance with the wavelength of a lamp for use in UV irradiation. As the lamp for use in UV irradiation, it is possible to use, e.g., a high-pressure mercury lamp, metal halide lamp, or xenon flash lamp.

The surface tension can be higher than that of the stamper and 39 mN/m or less. Although the surface tension can be made as high as possible, a high surface tension is impractical because isobornyl acrylate having a high etching resistance and a high-surface-tension material separate from each other after a film is formed.

The surface tension of the ultraviolet-curable resin material can be adjusted by the surface tensions of components to be blended. For example, the surface tension of the ultraviolet-curable resin material can be affected by the surface tension of an acrylate usable as the main component of the ultraviolet-curable resin material. The surface tension of the ultraviolet-curable resin material usable in the present invention generally increases as the order of a polyfunctional acrylate increases. Even when using a monofunctional acrylate, the surface tension is rarely lower than 31 mN/m. The ultraviolet-curable resin usable in the above embodiment uses isobornyl acrylate as a main agent, and the surface tension of isobornyl acrylate is 31.7 mN/m. Even when another monofunctional acrylate is mixed, therefore, the lower limit is 31 mN/m because a polyfunctional acrylate having a high surface tension is mixed.

The critical surface tension of the stamper can be adjusted by mixing an additive such as a release agent in the stamper molding material.

Alternatively, the critical surface tension can be adjusted by, e.g., forming a film on the stamper surface.

As the stamper molding material, it is possible to use, e.g., Zeonor 1060R cyclic olefin polymer available from Zeon or AD5503 polycarbonate material available from Teijin Chemicals.

As the release agent mixable in the stamper molding material, it is possible to use, e.g., a fluorine-based release agent, silicone, fatty acid ester, fatty acid amide, phosphoric acid ester containing a perfluoroalkyl group, monoglyceride, sodium laurate, or sodium lauryl sulfate.

Among the materials, glycerin monostearate, glycerin monopalmitate, glycerin monobehenate, glycerin monoorate, glycerin monodistearate, diglycerin laurate, diglycerin stearate, sorbitan laurate, and sorbitan palmitate are readily mixed in the molding material. Also, mixing a fluorine-containing release agent facilitates transfer of fine patterns.

The mixing amount of the release agent can be 0.1 to 5.0 wt % of the stamper molding material. If the mixing amount of the release agent is larger than 5.0 wt %, pattern molding often becomes difficult. If the mixing amount of the release agent is smaller than 0.1 wt %, it often becomes difficult to mold fine patterns from an Ni stamper.

Examples of the film formable on the stamper surface are Ni (99 atomic %)-V (1 atomic %) ion plating and a release agent coating layer.

The thickness of the film can be 1 to 10 nm.

If the film thickness is less than 1 nm, the film often peels off. If the film thickness exceeds 10 nm, grooves tend to deform.

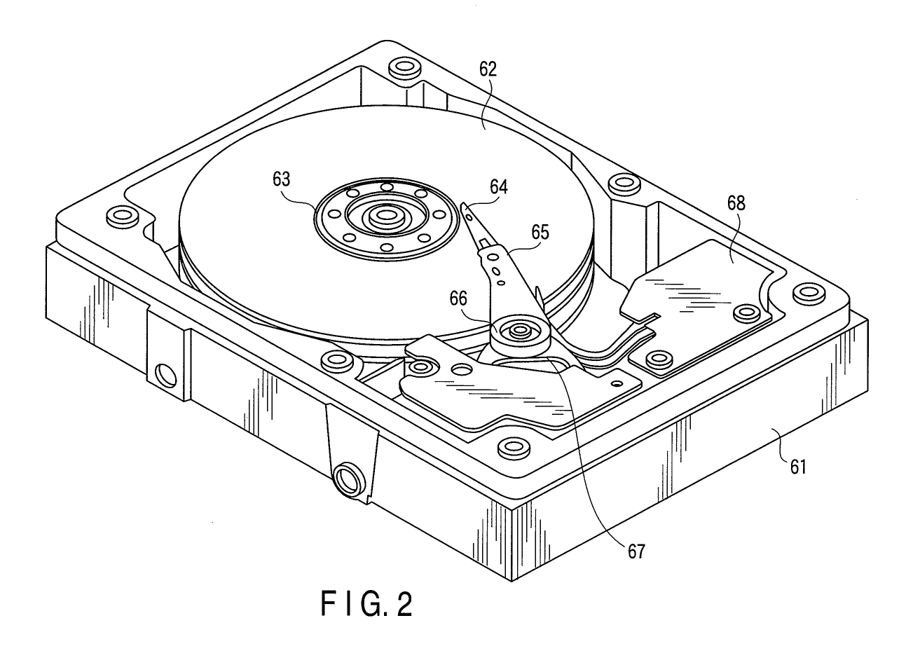

FIG. 2 is a view showing a magnetic recording/reproduction apparatus for performing recording and reproduction on the magnetic recording medium.

This magnetic recording apparatus includes, in a housing 61, a magnetic recording medium 62, a spindle motor 63 for rotating the magnetic recording medium 62, a head slider 64 including a recording/reproduction head, a head suspension assembly (a suspension 65 and actuator arm 66) for supporting the head slider 64, a voice-coil motor 67, and a circuit board.

The magnetic recording medium 62 is attached to and rotated by the spindle motor 63, and various digital data are recorded by the perpendicular magnetic recording method. The magnetic head incorporated into the head slider 64 is a so-called composite head, and includes a write head having a single-pole structure and a read head using a GMR film or TMR film. The suspension 65 is held at one end of the actuator arm 66, and supports the head slider 64 so as to oppose it to the recording surface of the magnetic recording medium 62. The actuator arm 66 is attached to a pivot 68. The voice-coil motor 67 is formed as an actuator at the other end of the actuator arm 64. The voice-coil motor 67 drives the head suspension assembly to position the magnetic head in an arbitrary radial position of the magnetic recording medium 62. The circuit board includes a head IC, and generates, e.g., a voice-coil motor driving signal, and control signals for controlling read and write by the magnetic head.

An address signal and the like can be reproduced from the processed magnetic recording medium by using this magnetic disk apparatus.

A magnetic disk in which the track density was 325 kTPI (Track Per Inch, equivalent to a track pitch of 78 nm) in a data zone having a radius of 9 to 22 mm was manufactured by using the method of the present invention.

To manufacture the magnetic disk having this servo area, imprinting is performed using a stamper having three-dimensional patterns corresponding to magnetic layer patterns on the magnetic disk. Note that the surface of the three-dimensional patterns of the magnetic layer formed by imprinting and subsequent processing may also be planarized by burying a nonmagnetic material in recesses.

A method of manufacturing the magnetic disk of this embodiment will be explained below.

First, a stamper was manufactured.

An Si wafer having a diameter of 6 inches was prepared as a substrate of a master as a template of the stamper. On the other hand, ZEP-520A resist available from Zeon was diluted to half with anisole, and the solution was filtered through a 0.05-μm filter. The Si wafer was spin-coated with the resist solution and prebaked at 200° C. for 3 minutes, thereby forming a resist layer about 50 nm thick.

An electron beam lithography system having a ZrO/W thermal field emission type electron gun emitter was used to directly write desired patterns on the resist onto the Si wafer at an acceleration voltage of 50 kV. This lithography was performed using a signal source that synchronously generates signals for forming servo patterns, burst patterns, address patterns, and track patterns, signals to be supplied to a stage driving system (a so-called X-θ stage driving system including a moving mechanism having a moving axis in at least one direction and a rotating mechanism) of the lithography system, and an electron beam deflection control signal. During the lithography, the stage was rotated at a constant linear velocity (CLV) of 500 mm/s, and moved in the radial direction as well. Also, concentric track areas were written by deflecting the electron beam for every rotation. Note that the feeding speed was 7.8 nm per rotation, and one track (equivalent to one address bit width) was formed by ten rotations.

The resist was developed by dipping the Si wafer in ZED-N50 (available from Zeon) for 90 sec. After that, the Si wafer was rinsed as it was dipped in ZMD-B (available from Zeon) for 90 sec, and dried by air blow, thereby manufacturing a resist master (not shown).

A conductive film made of Ni was formed on the resist master by sputtering. More specifically, pure nickel was used as a target. After a chamber was evacuated to 8×10⁻³ Pa, the pressure was adjusted to 1 Pa by supplying argon gas, and sputtering was performed in the chamber for 40 sec by applying a DC power of 400 W, thereby forming a conductive film about 10 nm thick.

The resist master having this conductive film was dipped in a nickel sulfamate plating solution (NS-160 available from Showa Chemical Industry), and Ni electroforming was performed for 90 minutes, thereby forming an electroformed film about 300 μm thick. The electroforming bath conditions were as follows.

Electroforming Bath Conditions

Nickel sulfamate: 600 g/L

Boric acid: 40 g/L

Surfactant (sodium lauryl sulfate): 0.15 g/L

Solution temperature: 55° C.

pH: 4.0

Current density: 20 A/dm²

The electroformed film and conductive film were separated together with the resist residue from the resist master. The resist residue was removed by oxygen plasma ashing. More specifically, plasma ashing was performed for 20 minutes by applying a power of 100 W in a chamber in which the pressure was adjusted to 4 Pa by supplying oxygen gas at 100 ml/min.

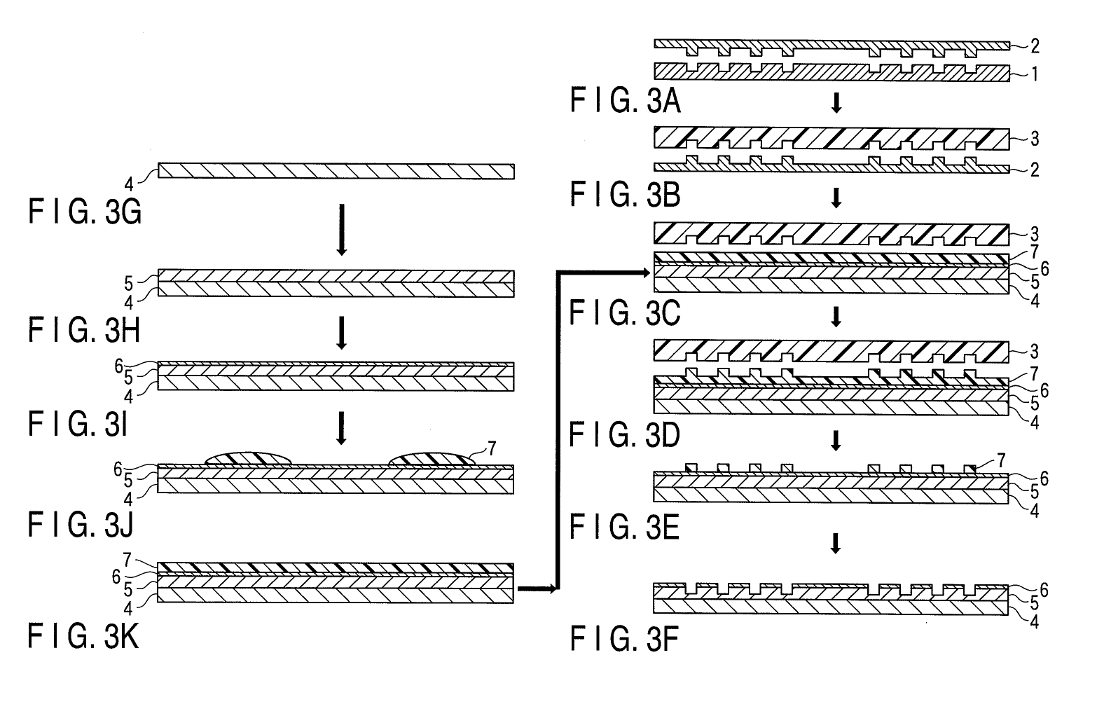

As shown in FIG. 3A, a father stamper 1 including the conductive film and electroformed film as described above was obtained. After that, electroforming was further performed to duplicate a mother stamper 2 as shown in FIG. 3B. An injection molding stamper was obtained by removing unnecessary portions of the mother stamper 2 by a metal blade.

As shown in FIG. 3C, a resin stamper 3 was duplicated from the mother stamper 2 by using an injection molding apparatus manufactured by TOSHIBA MACHINE. As the molding material, Zeonor 1060R cyclic olefin polymer available from Zeon was used. Note that the three-dimensional patterns of the resin stamper can have a main region corresponding to a data area including a data recording portion and address portion of a recording medium, and a dummy region except for the main region.

Then, a magnetic disk was manufactured.

A magnetic recording layer was formed by sputtering on a disk substrate made of doughnut-like glass 1.8 inches in diameter shown in FIG. 3G. A 3-nm-thick metal mask layer was stacked on this magnetic recording layer. Examples of a metal usable as the metal mask layer are Ag, Al, Au, C, Cr, Cu, Ni, Pt, Pd, Ru, Si, Ta, Ti, Zn, and alloys (e.g., CrTi, CoB, CoPt, CoZrNb, NiTa, NiW, Cr—N, SiC, and TiO_{X}) containing these metals. Among these metals, Si and Cu are superior in property of separation from a resin stamper and processability. The film thickness of the metal mask layer is determined by the processability, and can be as small as possible. In this embodiment, a 3-nm-thick Cu layer was stacked on the magnetic recording layer.

After a surface protection layer 6 was formed on a magnetic recording layer 5 as shown in FIG. 31, a resist 7 made of an ultraviolet-curable resin material was formed by spin coating at a rotational speed of 10,000 rpm as shown in FIG. 3J.

The ultraviolet-curable resin material used was formed by mixing 84 wt % of isobornyl acrylate represented by formula (1) below, 10 wt % of hexafunctional urethane acrylate represented by formula (2) below, and 6 wt % of Darocur 1173.

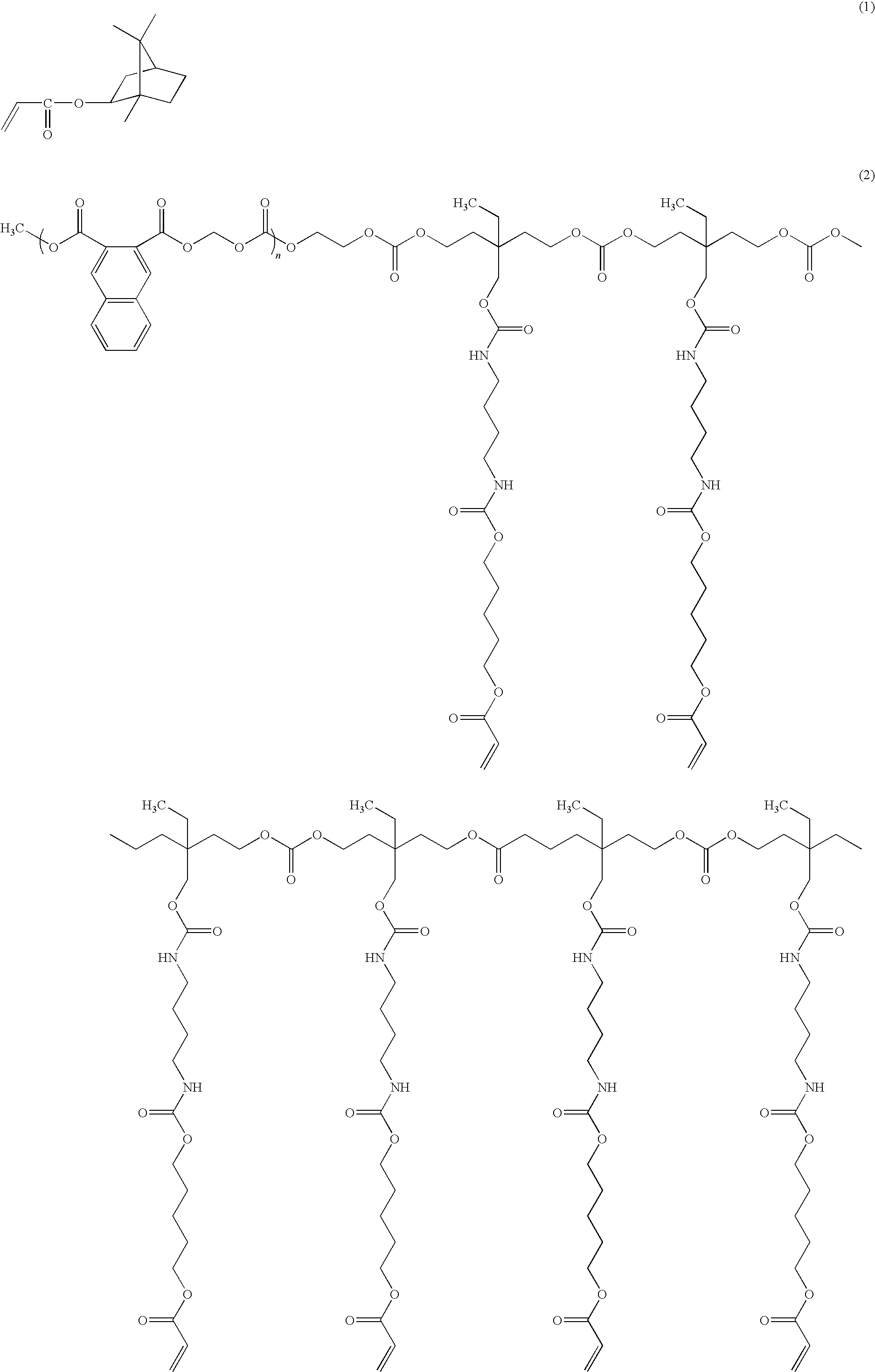

The surface tension of this ultraviolet resin was 32 mN/m. Note that the surface tension was measured with CBVP-Z automatic surface tensiometer manufactured by Kyowa Interface Science by using the plate method (Wilhelmy method). The ultraviolet-curable resin is not limited to this one, and can be selected from various types of ultraviolet-curable resins as described previously. The resin stamper 3 was bonded to the ultraviolet-curable resin resist 7 on the surface of the disk substrate by vacuum bonding, and the resin was cured by ultraviolet irradiation. After that, the resin stamper 3 was separated as shown in FIG. 3D.

In a three-dimensional pattern formation process performed by ultraviolet imprinting, the resist residue remains on the bottoms of pattern recesses.

Then, the resist residue on the bottoms of pattern recesses was removed by RIE using oxygen gas. As shown in FIG. 3E, the magnetic recording layer was etched by Ar ion milling by using the patterns of the resist 7 as masks. Subsequently, as shown in FIG. 3F, the resist patterns were removed by oxygen RIE. In addition, a carbon protective layer (not shown) was formed on the entire surface. After that, the manufactured magnetic disk was coated with a lubricant.

In the magnetic disk medium described above, the magnetic recording layer was etched to the bottom in a portion where no resist mask was formed. However, it is also possible to stop Ar ion milling halfway to obtain a medium having projections and recesses. Alternatively, it is possible to obtain a medium by imprinting a stamper onto a resist on a substrate without initially forming any magnetic layer, making the substrate shape three-dimensional in advance by etching or the like, and then forming a magnetic film. Furthermore, in any medium including the above-mentioned media, the grooves may also be filled with a certain nonmagnetic material.

The present invention will be explained in more detail below by way of its examples.

### Example 1

Resin stamper A was formed by injection molding by using one Ni stamper and an injection molding resin material obtained by mixing 1 wt % of glycerin monostearate as a release agent in AD5503 polycarbonate material available from Teijin Chemicals.

The critical surface tension was measured by the above-mentioned method, and found to be 31 mN/m.

By using the method shown in FIGS. 3C and 3D, resin stamper A having light transmission properties was bonded to a magnetic recording medium by interposing, between them, an ultraviolet-curable resin resist made of an ultraviolet-curable resin material formed by mixing 84 wt % of isobornyl acrylate represented by formula (1), 10 wt % of hexafunctional urethane acrylate represented by formula (2), and 6 wt % of Darocur 1173. After the resin was cured by ultraviolet irradiation, the resin stamper was separated.

The property of separation of the obtained resin stamper was visually checked when the stamper was separated. The evaluation was ∘ when no 2P resin remained, Δ when the 2P resin slightly remained, and X when the 2P resin remained in a wide area.

When the separated resin stamper was observed, no separation residue of the ultraviolet-curable resin was found.

Table 1 below shows the obtained result.

In addition, the groove shape was observed with an atomic force microscope (AFM), and it was found that patterns were well transferred.

### Example 2

Resin stamper B was formed by injection molding by using an injection molding resin material obtained by mixing 1 wt % of diglycerin stearate in Zeonor 1060R cyclic olefin polymer available from Zeon.

The critical surface tension was measured by the above-mentioned method, and found to be 29 mN/m.

The pattern transfer/separation test was conducted following the same procedures as in Example 1. When the separated resin stamper was observed, no separation residue of the ultraviolet-curable resin was found. Table 1 below shows the obtained result. The groove shape was also observed with the AFM, and it was found that patterns were well transferred.

### Example 3

Zeonor 1060R cyclic olefin polymer available from Zeon was used as an injection molding resin material, and a 10-nm-thick Ni (99 atomic %)-V (1 atomic %) layer was stacked by ion plating on an Ni stamper to be used in molding.

Resin stamper C was formed by injection molding by using this Ni stamper.

The critical surface tension was measured by the above-mentioned method, and found to be 29 mN/m.

The pattern transfer/separation test was conducted following the same procedures as in Example 1. When the separated resin stamper was observed, no separation residue of the ultraviolet-curable resin was found.

Table 1 below shows the obtained result.

The groove shape was also observed with the AFM, and it was found that patterns were well transferred.

### Example 4

An Ni stamper was spin-coated with a 6-nm-thick film of HD2100 available from Harves, and injection molding was performed using Zeonor 1060R cyclic olefin polymer available from Zeon as an injection molding resin material. In this manner, resin stamper D was obtained.

The critical surface tension was measured by the above-mentioned method, and found to be 28 mN/m.

The pattern transfer/separation test was conducted following the same procedures as in Example 1. When the separated resin stamper was observed, no separation residue of the ultraviolet-curable resin was found.

Table 1 below shows the obtained result.

The groove shape was also observed with the AFM, and it was found that patterns were well transferred.

### Example 5

The pattern transfer/separation test was conducted following the same procedures as in Example 1, except that a material obtained by mixing 50 wt % of isobornyl acrylate, 40 wt % of 2-phenoxyethyl acrylate, 7 wt % of ethoxylated (3) tetramethylolpropane triacrylate, and 3 wt % of Irgacure 369 as an ultraviolet-curable resin.

Separation was well done, and no separation residue was found.

Table 1 below shows the obtained result.

The surface tension of the ultraviolet-curable resin used was 38.5 mN/m.

### Comparative Example 1

Resin stamper E was formed by injection molding by using AD5503 polycarbonate material available from Teijin Chemicals as an injection molding resin material.

The critical surface tension was measured by the above-mentioned method, and found to be 35 mN/m.

The pattern transfer/separation test was conducted following the same procedures as in Example 1. When the separated resin stamper was observed, a separation residue of the ultraviolet-curable resin was found.

Table 1 below shows the obtained result.

### Comparative Example 2

Resin stamper F was formed by injection molding by using Zeonor 1060R cyclic olefin polymer available from Zeon as an injection molding resin material.

The critical surface tension was measured by the above-mentioned method, and found to be 33 mN/m.

The pattern transfer/separation test was conducted following the same procedures as in Example 1. When the separated resin stamper was observed, a separation residue of the ultraviolet-curable resin was found.

Table 1 below shows the obtained result.

### Comparative Example 3

The pattern transfer/separation test was conducted following the same procedures as in Example 1 by using an ultraviolet-curable resin having the same composition ratio and containing the same materials except that CD277 (acrylate ester) available from Sartomer was used instead of isobornyl acrylate. Consequently, the resin stamper and ultraviolet-curable resin were in tight contact with each other and could not be separated. The surface tension of the ultraviolet-curable resin was 29 mN/m.

Table 1 below shows the obtained result.

### Comparative Example 4

The test was conducted following the same procedures as in Example 1, except that a material obtained by mixing 30 wt % of isobornyl acrylate, 40 wt % of 2-phenoxyethyl acrylate, 23 wt % of ethoxylated (3) tetramethylolpropane acrylate, 3 wt % of Irgacure 369 was used as an ultraviolet-curable resin. The ultraviolet-curable resin was not mixed but became cloudy, and produced unevenness when applied to a magnetic recording medium. Although the resin could be separated, it could not be used as a pattern mask.

Table 1 below shows the obtained result.

### Comparative Example 5

Resin stamper G was formed by injection molding by using an injection molding resin material obtained by mixing 6 wt % of glycerin monostearate as a release agent in AD5503 polycarbonate material available from Teijin Chemicals. When patterns of the resin stamper were checked, the patterns were not transferred from an Ni stamper, so the resin stamper could not be used in the transfer/separation test after that.

Table 1 below shows the obtained result.

TABLE 1

| | | Critical | Surface | |
|---|---|---|---|---|
| | | surface | tension of | Property |
| | Resin | tension of | ultraviolet-curable | of |
| | stamper | stamper (mN/m) | resin (mN/m) | separation |
| Example 1 | A | 31 | 31.2 | ◯ |
| Example 2 | B | 29 | 31.2 | ◯ |
| Example 3 | C | 29 | 31.2 | ◯ |
| Example 4 | D | 28 | 31.2 | ◯ |
| Example 5 | A | 31 | 38.5 | ◯ |
| Comparative | E | 35 | 31.2 | X |
| Example 1 | | | | |
| Comparative | F | 33 | 31.2 | X |
| Example 2 | | | | |
| Comparative | A | 31 | 29.0 | X |
| Example 3 | | | | |
| Comparative | A | 31 | 40.5 | — |
| Example 4 | | | | |
| Comparative | G | — | 31.2 | — |
| Example 5 | | | | |

Examples 1 and 2 revealed that it was possible to increase the critical surface tension of the resin stamper by adding a release agent to the molding material, and improve the property of separation.

In Example 3, it was possible to increase the critical surface tension of the resin stamper by forming the Ni—V alloy film on the Ni stamper.

This is so probably because the thermal conductivity of the Ni stamper when using NiV was higher than that when using Ni, so cooling of the resin stamper surface improved during molding, and this changed the surface properties.

In Example 4, it was possible to increase the critical surface tension of the resin stamper by coating the Ni stamper with a release agent.

In Example 5, the property of separation improved by making the surface tension of the ultraviolet-curable resin higher than that of Example 1.

Comparative Examples 1 and 2 indicate that the critical surface tension can be changed by changing the molding material.

In Comparative Examples 3 and 4, when the surface tension of the ultraviolet-curable resin was lower than 31 mN/m or higher than 39 mN/m, the resin could not be used in pattern transfer to a magnetic recording medium.

In Comparative Example 5, a problem arose in pattern transfer when the amount of release agent mixed in the molding resin was larger than 5%.

Note that the resin stampers and ultraviolet-curable resins of Examples 1 to 5 in which pattern transfer was favorable were used to transfer patterns from the resin stampers, magnetic recording media were processed to form DTR media, and the recording/reproduction characteristics were checked. As a consequence, it was possible to obtain good characteristics.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A pattern transfer stamper comprising a three-dimensional pattern and an ultraviolet-curable resin coating layer to form a track pattern on a recording layer surface of a recording medium, wherein
a surface tension of the ultraviolet-curable resin is 31 to 39 mN/m, and
a critical surface tension of the stamper is 31 mN/m or less.

2. The stamper of claim 1, wherein the critical surface tension of the stamper is 26 to 31 mN/m.

3. A magnetic recording medium manufacturing method comprising:
contacting, under a vacuum, a magnetic recording layer surface of a magnetic recording medium to a resin stamper comprising a three-dimensional pattern surface and a critical surface tension of 31 mN/m or less, with an uncured ultraviolet-curable resin coating layer comprising a surface tension of 31 to 39 mN/m interposed therebetween;
curing the uncured ultraviolet-curable resin coating layer by ultraviolet irradiation;
separating the resin stamper to form a cured ultraviolet-curable resin layer comprising a transferred three-dimensional pattern on one surface of the magnetic recording medium; and
dry etching with the cured ultraviolet-curable resin material layer as a mask to form the three-dimensional pattern on the magnetic recording layer surface.

4. The method of claim 3, wherein the critical surface tension of the stamper is 26 to 31 mN/m.

5. A magnetic recording medium manufactured according to the method of claim 3.

6. A magnetic recording medium manufactured according to the method of claim 4.
